(19) United States
(12) Patent Application Publication
(10) Pub. No.: US 2026/0091937 A1
(43) Pub. Date: Apr. 2, 2026

(54) NAVIGATION SYSTEM FOR GUIDING A TARGET USER

(71) Applicant: Logistics and Supply Chain MultiTech R&D Centre Limited, Pok Fu Lam (HK)

(72) Inventors: Ka Lun Fan, Pok Fu Lam (HK); Bik Shan Lam, Pok Fu Lam (HK); Yuk Yu Lau, Pok Fu Lam (HK); Chun Pong Fu, Pok Fu Lam (HK); Nim Wai So, Pok Fu Lam (HK); King Loong Tse, Pok Fu Lam (HK)

(21) Appl. No.: 18/901,031

(22) Filed: Sep. 30, 2024

(51) Int. Cl. B65G 1/06; G01C 21/00; G01C 21/34

(52) U.S. Cl. CPC B65G 1/065; G01C 21/005; G01C 21/3407

(57) ABSTRACT

A navigation system for guiding a target user includes a user tracking module arranged to track the movement of the target user; a navigation vehicle arranged to guide the target user towards a predetermined destination through trajectory relative to the movement of the tracked target user; wherein the user tracking module is arranged to track the movement of the target user from a leading position relative to the movement of the tracked target user in a forward direction.

### TECHNICAL FIELD

The invention relates to a navigation system for guiding a target user, and particularly, although not exclusively, to a navigation system for guiding a target user across various industries and scenarios.

### BACKGROUND

With the booming of e-commerce in recent years, warehouse operation faces new challenges. Changing from B2B to B2C operation, warehouse logistics tasks become more fragmented.

Traditional “Follow-me” Robot can help the workers carry goods and follow them around the warehouse. This may alleviate the workload of warehouse operators and enhance the overall logistics efficiency to some extent.

### SUMMARY OF THE INVENTION

In accordance with a first aspect of the present invention, there is provided a navigation system for guiding a target user, comprising:
a user tracking module arranged to track the movement of the target user;
a navigation vehicle arranged to guide the target user towards a predetermined destination through trajectory relative to the movement of the tracked target user;
wherein the user tracking module is arranged to track the movement of the target user from a leading position relative to the movement of the tracked target user in a forward direction.

In accordance with the first aspect, the user tracking module is arranged to track the movement of the target user from a rearward direction opposite to the movement of the navigation vehicle in a forward direction.

In accordance with the first aspect, the user tracking module is arranged to determine the distance between the navigation vehicle and the target user and maintain a minimum distance therebetween, the minimum distance being greater or equal to at least a predetermined threshold.

In accordance with the first aspect, further comprising a controller configured to adjust the trajectory of the navigation vehicle based on the position of the target user.

In accordance with the first aspect, the controller is configured to adjust the speed of the navigation vehicle based on the distance between the navigation vehicle and the target user, the speed of the navigation vehicle being inversely proportional to the distance between the navigation vehicle and the target user.

In accordance with the first aspect, the user tracking module is arranged to track the presence of the target user within a region of interest and autonomously navigate to a predetermined temporary destination in response to the absence of the target user from the region of interest over a first predetermined time period.

In accordance with the first aspect, further comprising an image capturing module arranged to capture a plurality of images associated with the movement of the target user.

In accordance with the first aspect, the image capturing module further comprises a depth camera arranged to measure the distance between the navigation vehicle and the target user.

In accordance with the first aspect, the image capturing module is arranged to identify the facial feature associated with the target user from the captured images.

In accordance with the first aspect, the image capturing module is arranged to reidentify the facial feature associated with the target user from the captured images upon the target user is absent from the field of view of the image capturing module over a predetermined time period.

In accordance with the first aspect, the image capturing module is movably positioned on the navigation vehicle.

In accordance with the first aspect, the navigation vehicle further comprises a base on which the image capturing module is movably mounted whereby the orientation of the image capturing module is adjustable so as to maintain the target user within the field of view of the image capturing module.

In accordance with the first aspect, the user tracking module further comprises a pretrained object detection algorithm configured to process the images associated with the movement of the target user.

In accordance with the first aspect, the pretrained object detection algorithm comprises YOLO (You Only Look Once).

In accordance with the first aspect, further comprising an audio capturing module arranged to capture a plurality of audio outputs associated with the target user.

In accordance with the first aspect, further comprising a speech recognition module arranged to identify the verbal command by the target user from the captured audio output.

In accordance with the first aspect, the speech recognition module is arranged to trigger a voice command mode by comparing the captured audio output against a predetermined reference signal. In accordance with the first aspect, further comprising a communication module configured to publish one or more statuses associated with the navigation vehicle.

In accordance with the first aspect, the object tracking module is arranged to track the presence of the target user within a region of interest and alert the target user in response to the absence of the target user from the region of interest over a second predetermined time period greater than the first predetermined time period.

In accordance with the first aspect, the navigation vehicle is within the line of sight of the target user throughout the guidance of the target user towards the predetermined destination.

### BRIEF DESCRIPTION OF THE DRAWINGS

Embodiments of the present invention will now be described, by way of example, with reference to the accompanying drawings in which:

FIG. 1 is a schematic diagram showing the navigation system from a top perspective in accordance with an embodiment of the present invention.

FIG. 2 is a block diagram showing both software and hardware components of the navigation system in accordance with an embodiment of the present invention.

FIG. 3 is a flowchart showing the logic of the MeFollow main controller in accordance with an embodiment of the present invention.

FIG. 4 is a plot showing the relationship between the object distance and the robot speed in accordance with an embodiment of the present invention.

### DETAILED DESCRIPTION OF THE PREFERRED EMBODIMENTS

Without wishing to be bound by theory, the inventors have discovered that traditional “Follow-me” robots are designed to trail behind a target person, requiring the person to frequently look back to ensure the robot is still following. This constant need for visual confirmation can be inconvenient and distracting, especially when carrying important items or navigating through crowded environments. Additionally, if the robot loses sight of the target, it may become disoriented or stop functioning altogether, leaving the person stranded without their belongings.

In the present invention, the inventors have devised a “Front-Follow Me” robot (better known as “Me-Follow”) which reverses the roles of the robot and the target person in the traditional “Follow-me” robot i.e., allows the robot to lead the way while the person follows from behind. Accordingly, the present invention may mitigate one or more problems in the existing traditional “follow me” robots.

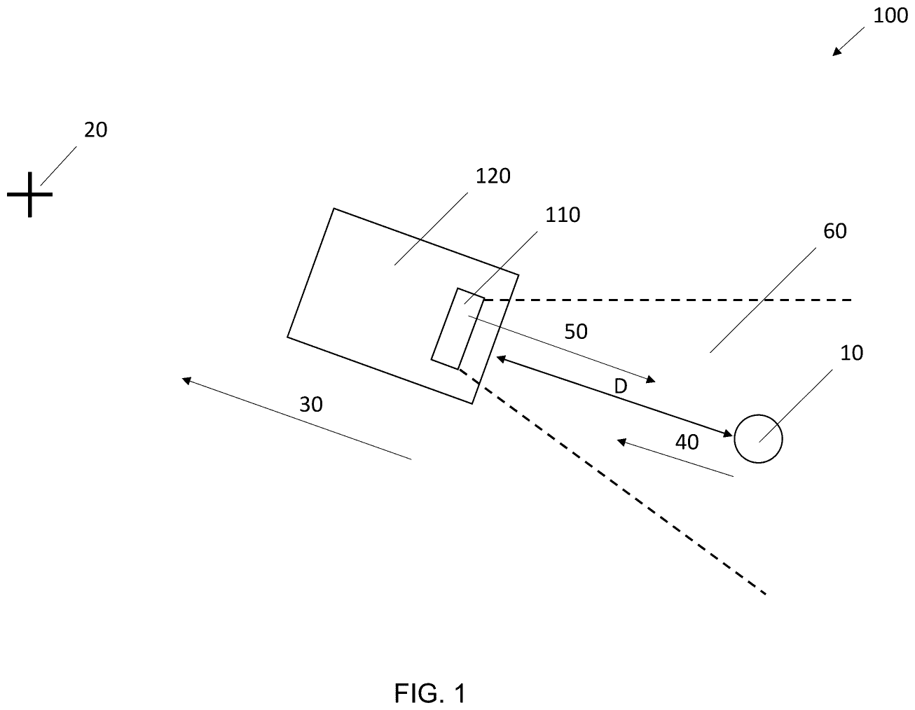

With reference to FIG. 1, there is shown an embodiment of a navigation system 100 for guiding a target user, comprising: a user tracking module 110 arranged to track the movement of the target user 10; a navigation vehicle 120 arranged to guide the target user 10 towards a predetermined destination 20 through trajectory relative to the movement of the tracked target user; wherein the user tracking module 120 is arranged to track the movement of the target user 10 from a leading position relative to the movement of the tracked target user 10 in a forward direction 30.

For the purposes of this document, the term “target user” includes any type of users, such as, but not limited to, human and non-human users such as animals, visual robots which may visually follow the trajectory of the navigation vehicle to reach the destination. The term “navigation vehicle” also includes any vehicles such as robots, land vehicles such as cars, bikes, scooters, water vehicles, flying vehicles or hybrid vehicles such as water cars, flying cars etc.

As show in FIG. 1 there is a shown a schematic diagram of a navigation system 100 and a target user 10 interacting with the navigation system 100. The navigation system 100 can be embodied as a navigation vehicle 120 on which a user tracking module 110 is mounted to track the position of the target user 10. The navigation vehicle 120 is navigated towards a predetermined destination 20 in a forward direction 30 and the trajectory of the navigation vehicle 120 may guide the target user 10 travelling towards the predetermined destination 20. As the navigation vehicle 120 navigates towards the predetermined destination 20 in the forward direction 30, the target user 10 may also follow the trajectory of the navigation vehicle 120 in a forward direction 40. Accordingly, the navigation vehicle 120 is maintained at a leading position relative to the target user 10 such that the navigation vehicle 120 is always within the line of sight of the target user 10.

To achieve the “Front-Follow Me” concept, the user tracking module 110 may be provided on the rear end of the navigation vehicle 120 and track the movement of the target user 10 from a rearward direction 50 opposite to the forward movement of the navigation vehicle 120 in the forward direction 30. The navigation vehicle 120 is kept within a minimal distance D from the target user 10 so that the target user 10 is tracked by the user tracking module 110 within a region of interest 60. For instance, the target user 10 may be tracked by an image capturing module within the field of view.

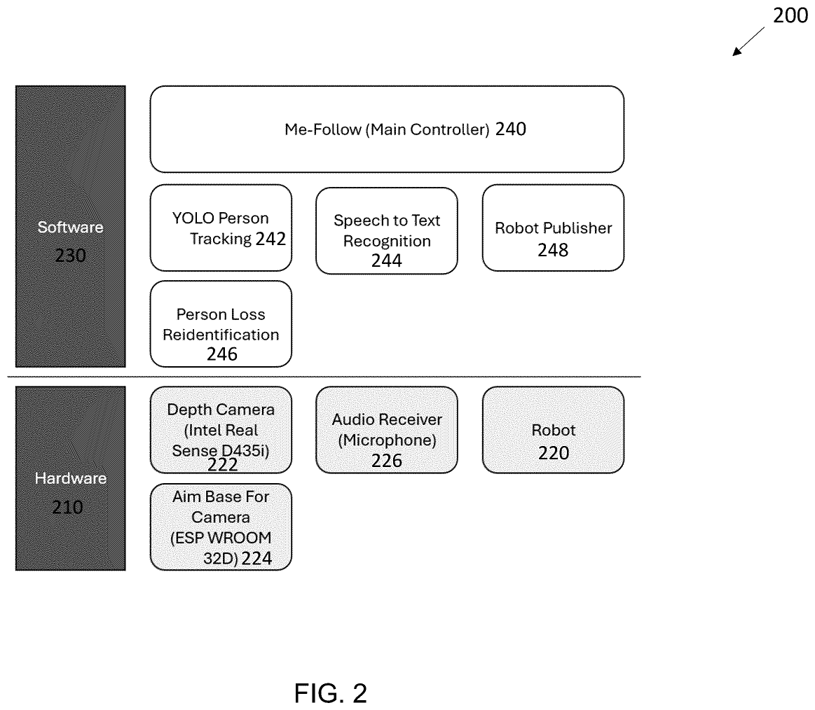

Referring to FIG. 2 for the further details of the overall architecture of the navigation system 100 in accordance with one example embodiment of the present invention which is implemented by a computer apparatus 200 equipped with a plurality of hardware 210 and software 230. The navigation system 100 can be embodied as a navigation vehicle 220 e.g., a robot embedded with the computing apparatus 200.

Essentially, computing apparatus 200 includes suitable components necessary to receive, store and execute appropriate computer instructions to implement the key capabilities of the “MeFollow” robot. The components may include a processing unit, including Central Processing United (CPUs), Math Co-Processing Unit (Math Processor), Graphic Processing United (GPUs) or Tensor processing united (TPUs) for tensor or multi-dimensional array calculations or manipulation operations, read-only memory (ROM), random access memory (RAM), and input/output devices such as disk drives, a user interface such as a keyboard, touchscreen. The processing unit may be a single processor to provide the combined functions of multiple processors. In this example embodiment, the computing apparatus 200 is configured to receive data associated with the apparatus 10 and the environment measured by external sensing units.

The hardware 210 of the computing apparatus 200 may further comprise one or more sensing units to capture a plurality of images or capture a video stream within a predetermined time period. The sensing unit here may be an image capturing module 222. The sensing unit is arranged in signal communication with the processing unit of the computing apparatus 200 such that the computing apparatus 200 is configured to receive recorded images or video from the sensing unit and process the images or video in real time.

In one example embodiment, the image capturing module 222 can be a depth camera. For instance, the depth camera 222 is arranged to capture a rear 3D view of the robot 220 so as to detect the presence of the target user 10 within a field of view. For instance, the target user 10 can be identified based on some matching of facial features of the target user 10. The depth camera 222 can be an Intel® RealSense™ depth camera D435i which combines the robust depth sensing capabilities with the addition of an inertial measurement unit (IMU).

Advantageously, there is also provided an aim base 224 with a pivotable joint such that the image capturing module 222 can be movably and rotatably mounted on the robot 220. For instance, the movement of the aim base 224 may be actuated by a motor which is in signal communication with the processing unit or a microcontroller of the computing apparatus 200 such that the speed and direction of the aim base 224 and the orientation of the image capturing module 222 can be adjusted to maintain the target user 10 within the field of view of the image capturing module 222. For instance, the microcontroller can be an Espressif ESP32-WROOM-32D.

The hardware 210 of the computing apparatus 200 may further comprise one or more sensing units to capture the audio output associated with the target user 10.

The sensing unit here may be an audio capturing module i.e., an audio receiver 226 e.g., a microphone which captures the sound data associated with the interaction between the target user 10 and the computing apparatus 200. The computing apparatus 200 may also include a speaker unit for providing audible information to the target user 10.

The computing apparatus 200 may also comprise other input devices such as an Ethernet port, a USB port, etc. Display such as a liquid crystal display, a light emitting display or any other suitable display and communications links (i.e., a communication interface). For instance, the computing apparatus 200 may further include a main controller 240 for signal communication with the various hardware 210 as aforementioned.

Preferably, the computing apparatus 200 may execute an application (app) to implement the various functions defined by the application. In particular, the computing apparatus 200 includes a plurality of software application 230 (i.e., an app) that is stored in a memory unit e.g., ROM or RAM or another memory unit. The software application 230 includes computer readable and executable instructions. The computing apparatus 200 is configured to execute the instructions to cause the processor to perform one or more functions defined in the instructions.

For instance, the navigation system may also incorporate integrated AI Person Tracking and speech recognition capabilities e.g., Voice-Activated Assistant. Accordingly, the system may be adopted for Deep Vision Automation and Deliverbot Assisted Medicine Dispensary and Delivery System in Transitional Care Management (TCM) Hospital Logistics.

In one example embodiment, the main controller 240 may be a “MeFollow” Main Controller 240 which may serve as the crucial integration point, seamlessly combining these disparate elements into a unified system. This controller 240 acts as the central hub for processing and decision-making, coordinating inputs from the YOLO Person Tracking system 242, speech recognition engine 244, reidentification module 246, and then translating these inputs into actionable commands for the robot.

In one example embodiment, there is provided a YOLO AI Person Tracking feature 242 which utilizes advanced computer vision and machine learning algorithms such as pretrained object detection algorithm e.g., YOLO (You Only Look Once) algorithm to process the images captured by the depth camera 222. For instance, the software application 230 is configured to execute the YOLO (You Only Look Once) algorithm for real-time object detection. By utilizing the YOLO (You Only Look Once) algorithm, the robot's camera 222 feed is analyzed in real-time to detect and track human figures associated with the target user 10. This enables the robot 220 to identify and follow a specific person in its field of view. Accordingly, the robot 220 can accurately identify and track individuals in its environment.

More preferably, the YOLO AI Person Tracking 242 may be assisted by an Aim-Based Person Tracking feature. The controller 240 may adjust the orientation and movement of the depth camera 222 to keep the tracked person centered in its field of view. The controller 240 continuously calculates the position of the person 10 relative to the robot 220 and adjusts its trajectory accordingly.

Advantageously, the combination of the AI Person Tracking feature and the Aim-Based Person Tracking feature together may allow the system 100 to accurately follow a target individual 10, even in the presence of occlusions or distractions.

In one example embodiment, there is also provided a Speech-to-Text Recognition feature 244 which leverages state-of-the-art speech recognition technology so that the robot 220 can understand and process verbal commands for enhancing its interactive capabilities. For instance, the software application 230 is configured to activate the Speech-to-Text Recognition 244 upon receiving a voice command with keyword. The audio receiver 226 may listen for a specific keyword to activate its voice command mode. Once activated, it can understand and process spoken instructions thereby allowing users 10 to control the robot 220 or give it commands verbally.

In one example embodiment, there is also provided a Person Loss Reidentification feature 246 which may implement advanced reidentification techniques to ensure that the robot 220 can recognize and reidentify a person 10 even after temporary occlusion or loss of visual contact. If the robot 220 temporarily loses sight of the person 10 it's following, this feature helps it reidentify the correct individual when they come back into view. It uses visual cues and patterns to ensure it continues following the right person 10.

Advantageously, if the target user 10 is loss from the field of view of the depth camera 222 over a predetermine time period, the controller 240 may command the robot 220 to autonomously navigate to a predetermined temporary destination in response to the absence of the target user 10 from the field of view of the depth camera 222. For instance, the controller 240 may command the robot 220 to revert to a former position at which the target user 10 was presence in the last captured image by the depth camera 222 at a specific time stamp.

In one example embodiment, there is also provided a Robot Publisher feature 248 which acts as a communication hub for publishing the robot's status, sensor data, and other relevant information to other parts of the system 200. This component facilitates seamless communication between the robot's various modules for ensuring synchronized operation and efficient data exchange. It ensures that all modules of the robot 220 (tracking, movement, voice recognition, etc.) are synchronized and can respond appropriately to changes in the environment or user commands.

Advantageously, these features may work together to create a seamless following experience, allowing the robot 220 to track and follow a person 10 while responding to voice commands and navigating its environment safely.

Moreover, the present invention may be designed to be modular, allowing it to be attached to any robot that uses the same communication protocol with very minor pre-setting. This modularity ensures that the navigation system 100 can be easily adapted and integrated into various robotic platforms, providing flexibility and scalability for different applications.

Preferably, the navigation system 100 may guide the user 10 towards the destination 20 while performing additional duties. By incorporating advanced AI capabilities, the robot of the present invention would not only be able to navigate and deliver more efficiently but also adapt to a wide range of scenarios, making it a more versatile and reliable solution for various applications beyond simple following or delivery tasks.

For instance, the computing apparatus 200 may also comprise advanced multimodal Large Language Models (LLMs) to further enhance capabilities and adaptability of the “Me-Follow” robot. These additions could significantly improve the robot's performance, especially in complex environments or specialized applications such as delivery services.

### 1) Visual Confirmation of Destinations

In one example embodiment, the integrating of multimodal LLMs can enable the robot to analyze images from its cameras 222 in real-time. This capability would allow the robot to verify that it has reached the correct destination by comparing visual cues with provided address information. It would also allow the robot to recognize specific landmarks or building features to ensure accurate navigation. The robot may also identify potential obstacles or challenges in the delivery path.

### 2) Environmental Awareness and Caution Levels

In one example embodiment, the multimodal LLMs can help the robot assess its surroundings and determine when extra caution is needed. For instance, the robot may recognize high-traffic areas or construction zones that require slower movement. The robot may identify weather conditions (e.g., rain, snow) that might affect navigation or package handling. The robot may also detect the presence of children or pets, prompting increased vigilance.

### 3) Enhanced Human-robot Interaction

In one example embodiment, the integration of multimodal LLMs could also improve the robot's ability to interact with humans. For instance, the robot may understand and respond to gestures or facial expressions. The robot may provide more natural and context-aware verbal responses. The robot may also offer visual feedback through an integrated display, showing that it understands complex instructions or situations.

### 4) Adaptive Decision Making:

In one example embodiment, the multimodal LLM capabilities may allow the robot to make more informed decisions based on a combination of visual, textual, and contextual information. For instance, the robot may choose optimal routes based on real-time visual assessment of traffic and pedestrian patterns. The robot may adjust its approach to different types of buildings or entrances. The robot may also make on-the-spot decisions about package placement or handover methods.

### 5) Improved Safety and Security:

In one example embodiment, the multimodal LLMs could enhance the robot's ability to ensure safe and secure deliveries. For instance, the robot may verify the identity of recipients through facial recognition combined with other authentication methods. The robot may detect suspicious activities or unauthorized attempts to access packages. The robot may also assess the safety of leaving packages in certain locations based on visual cues.

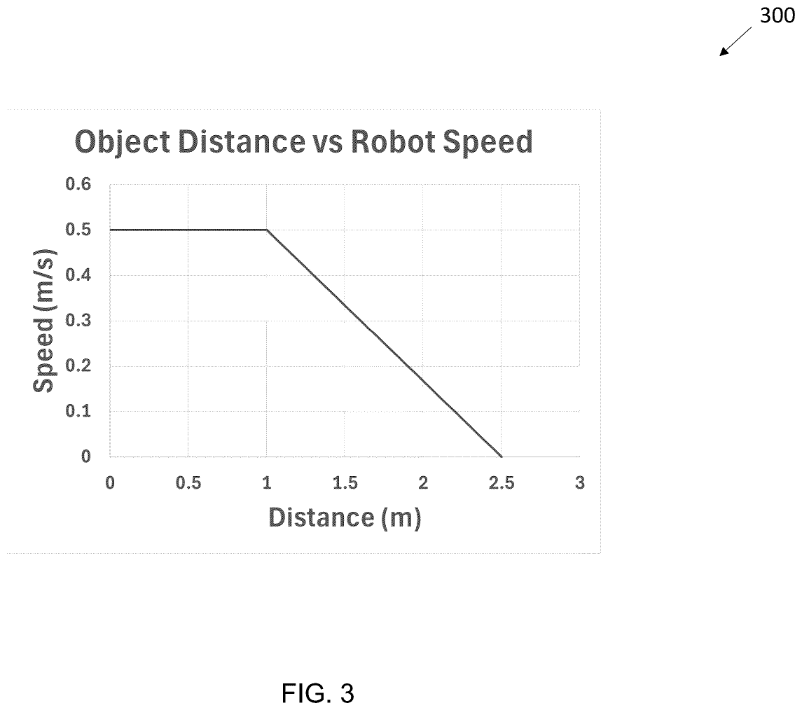

With reference to FIG. 3, there is shown the relationship between the speed of the robot 220 and the minimal distance D between the navigation vehicle 120 and the target user 10 as depicted in FIG. 1.

In this example embodiment, the “MeFollow” Main Controller 240 may be configured to perform some distance calculation and adjust its trajectory and relative position with respect to the robot 220 such that the robot 220 is kept within a minimal distance D from the target user 10 and the target user 10 can be tracked by depth camera 222 within the field of view.

For instance, the robot 220 may use depth camera 222 to measure the distance between itself and the person 10 it's following. This information is crucial for maintaining a safe and consistent following distance. It may use facial features to determine the real distance of a person. The main controller 240 will adjust the speed based on the calculated distance so that a minimum distance D between the robot 220 and the target user 10 is maintained which is greater or equal to a predetermine threshold.

Generally, the speed of the robot 220 would be inversely proportional to the distance D between the robot 220 and the target user 10. The closer the robot 220 to the target user 10, the higher the speed of the robot 220 is required to navigate away from the target user 10. As an illustration, the robot 220 may navigate at a constant speed of 0.5 m/s when the distance D between the robot 220 and the target user 10 is less than 1 m. As the robot 222 become further away from the target user 10, the robot 220 may navigate at a speed with a constant deceleration. As the robot 220 reaches the designated distance e.g., 2.5 m from the target user 10, the speed of the robot 220 would decrease to zero. As the target user 10 steps forward in a forward direction 40 and towards the robot 220, the robot 220 may navigate further away from the target user 10 again.

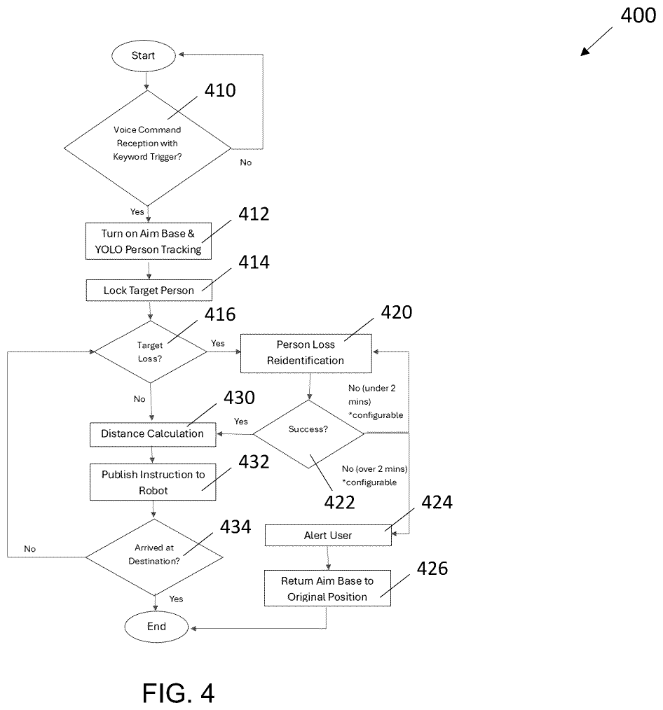

The operation mode of the navigation system 100 in accordance with one example embodiment of the present invention is now further described with reference to FIG. 4.

Referring to FIG. 4, the navigation method 400 for guiding a target user 10 begins with step 410. Step 410 comprises receiving the voice command with the keyword in order to trigger the navigation system 100. If the audio receiver 226 receives the voice command with the right keyword, the Speech-to-Text Recognition feature 244 would be triggered and the robot 220 can be commanded by the user 10 verbally and the navigation method 400 would subsequently proceed to step 412. If the audio receiver 226 cannot determine the keyword, the robot 220 would remain in the standby mode and repeat step 410.

Step 412 comprises turning on the YOLO AI Person Tracking feature 242 and the Aim-Based Person Tracking feature. The depth camera 222 would capture a plurality of images and the YOLO (You Only Look Once) algorithm would process the images to identify the target person 10 based on some matching of facial features. The orientation and movement of the depth camera 222 may also be adjusted by the aim base 224 to increase the depth of view during the tracking. Step 414 comprises locking the target person 10 within the region of interest 60. Once the target person 10 is identified, the target person 10 would be locked and the navigation would be provided to the same target person 10 until the navigation terminates at steps 426 or 434.

Step 416 comprises determining whether the target person 10 is loss from the region of interest 60. If the target user 10 is loss from the region of interest 60, the navigation method 400 would proceed to steps 420 and 422 instead. Step 420 comprises executing the Person Loss Reidentification feature 246 in order to reidentify the target person 10. Step 422 comprises determining whether the target person 10 can be reidentified. If the target person 10 can be reidentified instantly, the navigation method 400 would proceed to steps 430 and 432.

If the target person 10 cannot be reidentified within a predetermined threshold e.g., 2 minutes, step 420 shall be repeated. If the target person 10 cannot be reidentified over the predetermined threshold e.g., 2 minutes, it will proceed to steps 424 and 426 instead. Step 424 comprises alerting the target person 10 and step 426 comprises returning the aim base 224 to the original position. The navigation method 400 is interrupted.

If the target person 10 is within the region of interest 60, the navigation method 400 would skip step 420 and proceed to step 430 directly. Step 430 comprises calculating the distance D between the robot 220 and the target person 10. Step 432 comprises publishing instruction to the robot 220. Step 434 comprises determining whether robot 220 has arrived the destination 20. If the robot 220 has arrived the destination 20, the navigation method 400 is complete. If the robot 220 has not yet arrived the destination 20, the navigation method 400 would repeat step 416.

The “Me-Follow” approach in according with one example embodiment of the present invention offers several advantages:

### 1. Uninterrupted Monitoring

By having the robot in front, the person can easily monitor its movements and location without needing to constantly turn their head backward. This ensures a seamless and uninterrupted following experience, reducing the risk of losing sight of the robot or becoming separated.

### 2. Hands-free Navigation

With the robot leading the way, the person can focus on their surroundings and navigate through crowded or complex environments without the added burden of guiding the robot. This is particularly beneficial when carrying bulky or heavy items, as the person's hands remain free.

### 3. Enhanced Safety

By keeping the robot within their line of sight, the person can quickly react to any potential obstacles or hazards, preventing collisions or accidents that could occur if the robot were trailing behind.

### 4. Improved Tracking and Recovery

The integration of advanced AI person tracking and speech recognition technologies ensures that the robot can accurately follow the target person, even in the presence of occlusions or distractions. If the person becomes separated from the robot, it can autonomously navigate to a predetermined destination and wait for their return, reducing the risk of losing valuable items or becoming stranded.

Advantageously, the market opportunities for the innovative “Me-Follow” robot in accordance with one example of the present invention are vast, spanning industries that require efficient transportation, navigation assistance, or hands-free operation while carrying valuable or bulky items. For instance, the “Me-Follow” robot with integrated AI person tracking and speech recognition capabilities has numerous potential applications across various industries and scenarios:

### 1. Hospitality and Tourism

Hotels, resorts, and tourist attractions could employ these robots to assist guests with luggage transportation, navigation, and information delivery. Guests could simply instruct the robot to lead them to their desired destination, freeing their hands and allowing them to enjoy the surroundings without worrying about carrying heavy bags or getting lost.

### 2. Healthcare and Assisted Living

In healthcare facilities and assisted living communities, these robots could aid in transporting medical supplies, equipment, or personal belongings for patients or residents. The hands-free navigation and speech control features would be particularly beneficial for individuals with mobility challenges or those carrying medical devices.

### 3. Retail and Warehousing

Large retail stores, shopping malls, and warehouses could utilize these robots to assist customers or employees in locating and transporting merchandise or inventory. The AI person tracking capabilities would ensure that the robot stays with the designated individual, even in crowded or complex environments.

### 4. Airports and Transportation Hubs

Airports, train stations, and other transportation hubs could employ these robots to guide travelers to their gates, baggage claim areas, or other destinations while carrying their luggage. The speech recognition feature would allow for easy navigation and reduce the need for constant visual monitoring.

Although not required, the embodiments described with reference to the figures can be implemented as an application programming interface (API) or as a series of libraries for use by a developer or can be included within another software application, such as a terminal or personal computer operating system or a portable computing device operating system. Generally, as program modules include routines, programs, objects, components and data files assisting in the performance of particular functions, the skilled person will understand that the functionality of the software application may be distributed across a number of routines, objects or components to achieve the same functionality desired herein.

It will also be appreciated that where the methods and systems of the present invention are either wholly implemented by computing system or partly implemented by computing systems then any appropriate computing system architecture may be utilized. This will include tablet computers, wearable devices, smart phones, Internet of Things (IoT) devices, edge computing devices, standalone computers, network computers, cloud-based computing devices and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. A navigation system for guiding a target user, comprising:
a user tracking module arranged to track the movement of the target user;
a navigation vehicle arranged to guide the target user towards a predetermined destination through trajectory relative to the movement of the tracked target user;
wherein the user tracking module is arranged to track the movement of the target user from a leading position relative to the movement of the tracked target user in a forward direction.

2. The navigation system in accordance with claim 1, wherein the user tracking module is arranged to track the movement of the target user from a rearward direction opposite to the movement of the navigation vehicle in a forward direction.

3. The navigation system in accordance with claim 1, wherein the user tracking module is arranged to determine the distance between the navigation vehicle and the target user and maintain a minimum distance therebetween, the minimum distance being greater or equal to at least a predetermined threshold.

4. The navigation system in accordance with claim 3, further comprising a controller configured to adjust the trajectory of the navigation vehicle based on the position of the target user.

5. The navigation system in accordance with claim 3, wherein the controller is configured to adjust the speed of the navigation vehicle based on the distance between the navigation vehicle and the target user, the speed of the navigation vehicle being inversely proportional to the distance between the navigation vehicle and the target user.

6. The navigation system in accordance with claim 1, wherein the user tracking module is arranged to track the presence of the target user within a region of interest and autonomously navigate to a predetermined temporary destination in response to the absence of the target user from the region of interest over a first predetermined time period.

7. The navigation system in accordance with claim 1, further comprising an image capturing module arranged to capture a plurality of images associated with the movement of the target user.

8. The navigation system in accordance with claim 7, wherein the image capturing module further comprises a depth camera arranged to measure the distance between the navigation vehicle and the target user.

9. The navigation system in accordance with claim 7, wherein the image capturing module is arranged to identify the facial feature associated with the target user from the captured images.

10. The navigation system in accordance with claim 9, wherein the image capturing module is arranged to reidentify the facial feature associated with the target user from the captured images upon the target user is absent from the field of view of the image capturing module over a predetermined time period.

11. The navigation system in accordance with claim 1, wherein the image capturing module is movably positioned on the navigation vehicle.

12. The navigation system in accordance with claim 11, wherein the navigation vehicle further comprises a base on which the image capturing module is movably mounted whereby the orientation of the image capturing module is adjustable so as to maintain the target user within the field of view of the image capturing module.

13. The navigation system in accordance with claim 7, wherein the user tracking module further comprises a pretrained object detection algorithm configured to process the images associated with the movement of the target user.

14. The navigation system in accordance with claim 13, wherein the pretrained object detection algorithm comprises YOLO (You Only Look Once).

15. The navigation system in accordance with claim 1, further comprising an audio capturing module arranged to capture a plurality of audio outputs associated with the target user.

16. The navigation system in accordance with claim 15, further comprising a speech recognition module arranged to identify the verbal command by the target user from the captured audio output.

17. The navigation system in accordance with claim 16, wherein the speech recognition module is arranged to trigger a voice command mode by comparing the captured audio output against a predetermined reference signal.

18. The navigation system in accordance with claim 1, further comprising a communication module configured to publish one or more statuses associated with the navigation vehicle.

19. The navigation system in accordance with claim 6, wherein the object tracking module is arranged to track the presence of the target user within a region of interest and alert the target user in response to the absence of the target user from the region of interest over a second predetermined time period greater than the first predetermined time period.

20. The navigation system in accordance with claim 1, wherein the navigation vehicle is within the line of sight of the target user throughout the guidance of the target user towards the predetermined destination.
